(19) United States
(12) Patent Application Publication
(10) Pub. No.: US 2024/0092170 A1
(43) Pub. Date: Mar. 21, 2024

(54) Visible Component for a Motor Vehicle, and Motor Vehicle Having Visible Component

(71) Applicant: Bayerische Motoren Werke Aktiengesellschaft, Muenchen (DE)

(72) Inventors: Falco HOLLMANN, Garching (DE); Cornelia REINHARDT, Furth (DE); Mirko SCHADE, Landshut (DE); Bernhard ZEILMEIER, Geisenhausen (DE)

(21) Appl. No.: 18/274,247

(22) PCT Filed: Feb. 2, 2022
(86) PCT No.: PCT/EP2022/052451

§ 371 Date: Jul. 26, 2023

(30) Foreign Application Priority Data
Mar. 25, 2021 (DE) 10 2021 107 572.6

(51) Int. Cl. B60K 35/00; B32B 5/02; B32B 5/26; B60R 13/02

(52) U.S. Cl. CPC B60K 35/00; B32B 5/024; B32B 5/263; B60R 13/02; B32B 2260/021; B32B 2260/046; B32B 2262/101; B32B 2307/412; B32B 2307/42; B32B 2307/718; B32B 2307/7376; B32B 2457/20; B32B 2605/00; B60K 2370/1438; B60K 2370/33; B60K 2370/339

(57) ABSTRACT

A visible component for a motor vehicle includes a fiber-reinforced plastics component having a multi-layer fiber reinforcement which is integrated in an at least largely transparent plastics matrix. The fiber reinforcement is formed by a visible layer in the form of a metallized glass fiber layer and at least one largely transparent structural layer. A touch display is also provided on a rear face of the fiber-reinforced plastics component facing the visible layer.

### BACKGROUND AND SUMMARY OF THE INVENTION

The invention relates to a visible component for a motor vehicle, especially an interior component, and to a motor vehicle having a visible component.

The current trend in motor vehicle interiors is toward minimalistic designs with smooth surfaces and few buttons and switches. Shy-tech is a buzzword that refers to technical functionalities that are not visible at first glance, but only become visible as desired or when required. For instance, Continental has developed “morphing controls”, where controls hidden behind a kind of synthetic leather appear only when approached by the hand. Button-like backlit control surfaces then automatically stand out spatially from a previously smooth surface.

BMW, in the cockpit of the iNext showcar, presented an operable wood surface: apart from the steering wheel and driver display, there are no apparent displays or switches. They are integrated, for example into the wood surface of the center console. The hand lies on the perforated wood surface; on input, the finger is tracked by dots of light.

In addition, there are customers interested in motorsports who value a lightweight construction look. In this context, typically fiber-reinforced polymer components are used, where carbon fiber layers are incorporated into a transparent matrix material. In this way, the way in which the fibers run within the component is apparent to the customer, and the result is a visually high-quality depth effect.

Against this background, it is an object of the invention to specify a visible component for a motor vehicle that provides a shy-tech function and simultaneously enables new freedom of configuration with regard to the outward appearance. In particular, a solution by which a shy-tech solution can be combined with a high-quality visible fiber look in one component is to be specified.

The object is achieved by the claimed visible component and the claimed vehicle.

A visible component for a motor vehicle is specified, having a multilayer fiber reinforcement incorporated into an at least largely transparent polymer matrix. The fiber reinforcement is formed by a visible layer in the form of a metallized glass fiber layer and at least one largely transparent structure layer. In addition, a touch display is disposed on the reverse side of the fiber-reinforced polymer component which is remote from the visible layer.

The fiber composite body may form a main body of the visible component and as such essentially define the outer contours and the shape of the visible component; for example, the fiber composite body may delineate the complete visible surface of the component. The fiber composite body may additionally preferably also define the mechanical properties of the visible component, for example flexural strength or torsion stiffness. The fiber composite body may alternatively also form just part of the area of the visible component or be buttressed by a main body. The visible component may have further elements, for example securing devices or receptacles for securing devices.

In the installed state, a visible side of the visible component is visible. The fiber composite body is disposed toward a visible side of the visible component and is likewise visible in the installed state. The fiber reinforcement in the fiber composite body has two or more fiber layers one on top of another, with that fiber layer closest to the visible side being referred to as visible layer. If the visible component is viewed from its visible side, the visible layer is visible through the matrix material.

The fiber reinforcement also has one or more structure layers. The structure layer(s) is/are likewise fiber layer(s). The structure layers essentially define the mechanical properties of the visible component. The visible layer may, but need not, contribute to the structural strength of the component. The structural layers are formed from a material which is at least largely transparent in a composite with the matrix material. The expression “at least largely transparent” should be understood such that the material referred to as largely transparent is transparent to the predominant portion of light visible to man, and that, when illuminated, the contours of a nontransparent body behind it are clearly apparent. The at least largely transparent fiber layers and the at least largely transparent polymer matrix may also be fully transparent.

In other words, the visible component has at least one largely transparent fiber composite body into which is integrated, as well as at least one largely transparent fiber layer, additionally a single visible layer formed from metallized glass fibers. To put it another way, the fiber composite material preferably consists of a visible layer which is formed from metallized glass fibers, and which is embedded into an at least largely transparent composite composed of one or more structure layer(s) and polymer matrix. A touch display is disposed on the reverse side of said fiber composite body.

The effect achieved by this construction is as follows: the visible component under daylight (without backlighting) looks like a conventional visible component with a visible fiber look. The metallized glass fiber layer reflects a majority of the light, as a result of which this visible layer is visible to the viewer and looks like a conventional metal fiber layer or carbon fiber layer. At the same time, the fact that the underlying fiber composite construction is largely transparent is hidden. The metallized glass fiber layer makes the visible component look like a conventional visible component under incident light. If, by contrast, the touch display on the reverse side of the fiber composite body is activated and lit, the layer construction is lit through the display from the reverse side. In this case—because of the largely transparent fiber composite construction—a majority of the light passes through the fiber composite body, and the information presented on the display is readily apparent. For this purpose, only a relatively low light intensity is needed, since the fiber composite body absorbs only a little incoming light owing to its construction.

The (wall) thickness of the fiber composite body and the number of structure layers are chosen such that the touch display is operable from the visible side through the fiber-reinforced polymer component. What is meant by operable is that a user is able to make inputs on the touch display by touching the fiber composite body above the touch display. What is meant by a touch display—also called a touchscreen—is a combined input and output device where an image is generated on a screen. There is a touchpad below or above the screen that makes the image touch-sensitive. By contact with parts of the screen, it is possible to directly control a technical device, usually a computer. The touch display is preferably a resistive or capacitative touch display. The wall thickness of the fiber composite body is preferably within a range up to 1.2 mm inclusive and more preferably within a range up to 0.9 mm inclusive. Experiments have shown good operability both of resistive and capacitative touch displays for these wall thicknesses.

The fiber composite body on the touch display preferably looks similar to a protective glass on a touch display of a cellphone: it firstly offers protection from damage, and secondly also allows operation of the touch display. The touch display is secured on the fiber composite body in a manner suitable for the functionality described. It is conceivable, for example, to secure the touch display on the fiber composite body via suitable securing solutions in such a way that the display is in full-area contact with the fiber composite body. For example, the touch display may stick to the reverse side of the fiber composite body via adhesion, for example using an adhesion promoter. In a preferred configuration, the touch display is bonded to the reverse side of the fiber composite body, preferably over the full area. For this purpose, preference is given to using a visually clear adhesive as known for bonding of displays. Such a manner of securing is firstly durable and insensitive to agitation, and thus guarantees operability even during the driving operation of the vehicle. In addition, bonding enables exchange of the display in the case of a repair.

The solution described provides a shy-tech function: only with the touch display activated is it apparent to and usable by the user; otherwise, it disappears optically behind the visible layer of the fiber composite body.

The visible layer is formed by a metallized glass fiber layer. Glass fibers as such are milky-cloudy and translucent. The metallization, which can be effected, for example, in the form of vapor deposition, coats the glass fiber layer with a very thin metal layer. It has been found here that, surprisingly, a glass fiber layer metallized by vapor deposition does not limit the operability of the touch display. The thickness of the metal layer is preferably chosen such that the glass fiber under incident light looks like a metal fiber to a user. It may be advantageous when the metal layer has a thickness within a range from 10 nm to 100 nm and especially within a range from 40 nm to 70 nm.

In a preferred configuration, the thickness of the metallization or metal deposition is at the same time kept sufficiently thin that the metallized glass fiber still remains translucent when light is shone through it. This has the advantage that, when the visible component is backlit from the reverse side of the component, the light also shines through the metallized glass fibers. While the structure of the visible layer in the illuminated component remains visible to the user when an opaque visible layer is used, the structure of the visible layer may largely or even completely disappear to the viewer with such a metallized glass fiber layer, and an even more distinct and clear light effect may be achieved.

The metallization or vapor deposition can be conducted with various metals, for example with aluminum, silver, gold, etc. The respective thicknesses of the metal layer depend upon factors including the metal and the method used. In order to achieve the above-described effect, it has been found to be particularly advantageous in one configuration when the metallized glass fiber layer is an aluminum-metallized glass fiber layer and the aluminum layer has a thickness within a range from 40 nm to 70 nm, preferably within a range from 40 nm to 60 nm and especially preferably within a range from 45 nm to 55 nm.

The visible layer may be formed, for example, by a weave, a laid scrim, a knit, a nonwoven or a braid.

The at least one structure layer preferably takes the form of a glass fiber layer. If two or more structure layers are disposed in the fiber-reinforced polymer component, it is particularly preferable when all structure layers take the form of glass fiber layers. The individual layers of glass fibers may take the form of directed fiber layers, for example of a laid scrim, weave, braid or the like, or of undirected fiber layers, for example of a nonwoven. If glass fibers are infiltrated with a largely transparent matrix material, they will likewise become largely transparent.

The visible component—like conventional fiber composite components—can be produced by known and mass production-compatible methods, for example wet pressing or resin transfer molding (RTM). It is also possible to use prepregs, which are then processed further, for example, in an autoclave. In this context, there is no need either for additional manufacturing steps or for additional plant components, which means that production can be effected inexpensively.

The polymer matrix of the visible component is largely transparent. In principle, the polymer matrix may be a thermoset or thermoplastic polymer matrix. For the production of visible components that must meet high mechanical demands, it may be advantageous when the polymer matrix is a thermoset polymer matrix.

In order to achieve multicolor light effects, the fiber composite body, in one configuration, may also include one or more color filter layer(s). The color filter layer(s) is/are preferably disposed on the surface of the fiber composite body adjacent to the visible layer. The color filter layers may, for example, cover the entire fiber composite body or only parts thereof. The color filter layers act like a color filter and allow only particular wavelengths of light to pass through. The color filter layers may, for example, be formed by transparent or translucent color layers, for example paint layers or glaze layers.

Further color effects or light effects can be created in a configuration in which the touch display is a transparent touch display and, in addition, a light source is provided, disposed on a side of the touch display remote from the visible layer, in which case light which is emitted from the light source backlights the touch display and the fiber-reinforced polymer component in the direction of the visible layer. Viewed from the visible side of the component, the light source is thus disposed behind the transparent touch display. The transparent touch display may be configured, for example, as an OLED display, which results in good visibility of the information displayed with otherwise high transparency. The light source and touch display may be operated separately or collectively, which results in a great deal of freedom of optical configuration. The light source may be secured, for example, to the fiber composite body. The light source may, for example, be an LED. In one configuration, particularly uniform lighting is achieved with a small requirement for built space, in that the light source used is a two-dimensional light source, for example an electroluminescent film or the like.

A particularly advantageous configuration is one in which the reverse side of the fiber composite body has a three-dimensional surface profile, and a flexible display is installed as touch display. If the reverse side has a three-dimensional surface profile, the area may, for example, have single or multiple curvature or be configured as a free-form surface. The flexibility of the touch display in this configuration nevertheless enables full contact with the reverse side of the fiber composite body and hence unrestricted operability and visibility of the information displayed. This increases freedom of design in the configuration of visible component.

The visible component may, for example, be an interior component of a motor vehicle, for example an inner trim part, an armrest, a seat bucket or the like. Visible component may alternatively be an exterior component of a motor vehicle, for example a mirror cap, spoiler, motor vehicle hatch or the like.

The integration of the touch display into the above-describe visible component makes it possible also to provide surfaces in a visible fiber look with technical functionality. For example, by way of the touch display, it is possible to implement switch functions or adjust settings in vehicle components. For this purpose, the user is able to use their fingers or, if appropriate, a stylus provided for the purpose to press or scan across the visible component and hence operate the touch display beneath.

In a further aspect, the invention relates to a motor vehicle having an above-described visible component. The touch display is preferably set up to operate a vehicle component, meaning that a user can use the touch display to change settings in a vehicle component. The vehicle component operated by way of the touch display may, for example, be an electrical seat setting, a seat heater, a lighting function within the vehicle, and air conditioning system or a music system. The touch display is then in an appropriate functional connection (e.g. wireless or wired) to the vehicle component to be operated or to a central control device.

Further advantages, features and details of the invention will be apparent from the description that follows, in which working examples of the invention are described specifically with reference to the drawings. The features mentioned in the claims and in the description may each be essential to the invention on their own or in any combination. Where the word “may” is used in this application, this means both the technical possibility and the actual technical implementation.

Working examples are elucidated hereinafter with reference to the appended drawings.

### BRIEF DESCRIPTION OF THE DRAWINGS

FIG. 1 shows a section view of an illustrative visible component.

FIG. 2 shows an exploded view of the visible component of FIG. 1.

FIGS. 3 and 4 show top views of the visible component of FIG. 1 with deactivated and activated touch display.

FIGS. 5 to 7 show section views of further illustrative visible components.

### DETAILED DESCRIPTION OF THE DRAWINGS

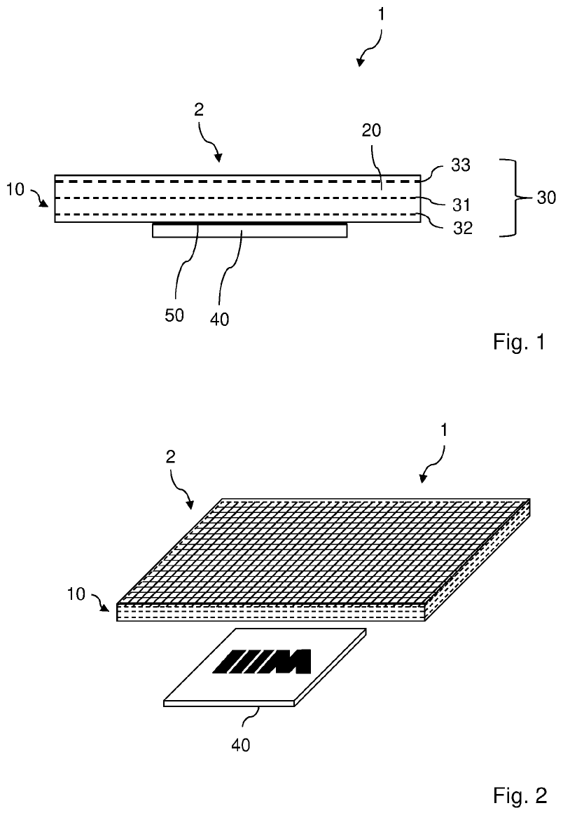

FIG. 1 shows a first illustrative visible component 1. The visible component 1 has a fiber composite body 10 which is formed by a polymer matrix 20 into which a fiber reinforcement 30 is embedded. The fiber reinforcement 30 is formed by two or more fiber layers that are layered one on top of another to form a stack. The fiber reinforcement 30 consists, by way of example, of two structure layers 31 and 32, and a visible layer 33. The visible layer 33, being the uppermost layer, faces the visible side 2 of the visible component 1. The visible layer 33 and the structure layers 31 and 32 may preferably take the form of directed fiber layers; the visible layer 33 preferably takes the form of a weave or laid scrim.

The polymer matrix 20 and the structure layers 31 and 32 are transparent or largely transparent. For example, a transparent polymer matrix and structure layers made of glass fibers are used. If the glass fiber layers are infiltrated with the transparent polymer matrix, they likewise become transparent or largely transparent. By contrast, the visible layer 33 takes the form of a metallized glass fiber layer. The visible layer 33—viewed from the visible side of component 1—is visible through the polymer matrix 20. In the unlit state, the visible component 1 acts like a conventional visible component, for example in a metal fiber look.

Also disposed on the reverse side of the component 1—i.e. the side remote from the visible layer 2—is a touch display 40 bonded to the fiber composite body 10 over the full area by an adhesive layer 50.

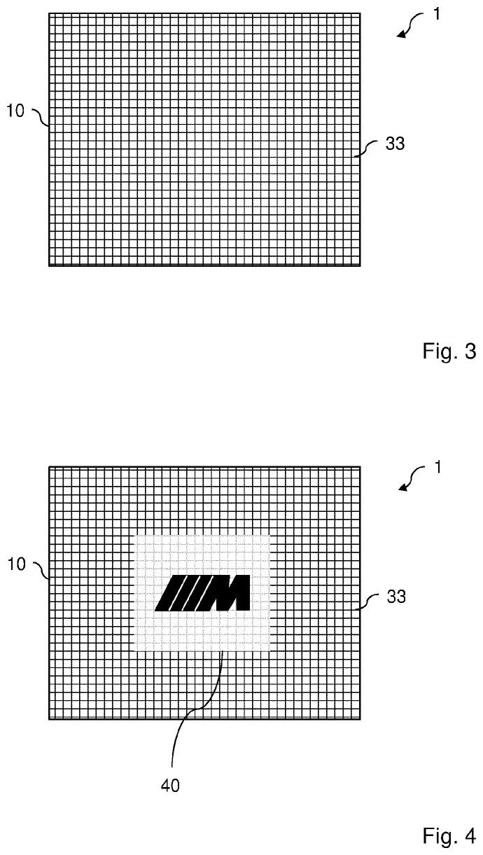

FIG. 2 shows a view of the visible component 1 before the touch display 40 is bonded to the fiber composite body 10. In the activated state of the touch display, information is shown on the screen (represented here by way of example as a logo). The touch display offers the further functionality that the display can be altered by touching the screen, for example made smaller or larger, moved etc. Such a touch display, by touching the screen, also enables the selection or activation of stored functions. For example, the touch display, when installed in the vehicle, be coupled to a vehicle component or a control device and enable, for example, the activation of a seat heater, alteration of air conditioning settings or the like. The fiber composite body 10, because of its construction with the fiber reinforcement composed of a metallized glass fiber layer and at least one further glass fiber layer, enables maintenance of the operability of the touch display even when the fiber composite body 10 is adhesive bonded to the touch display. This means that the touch display can be operated by touching the fiber composite body 10.

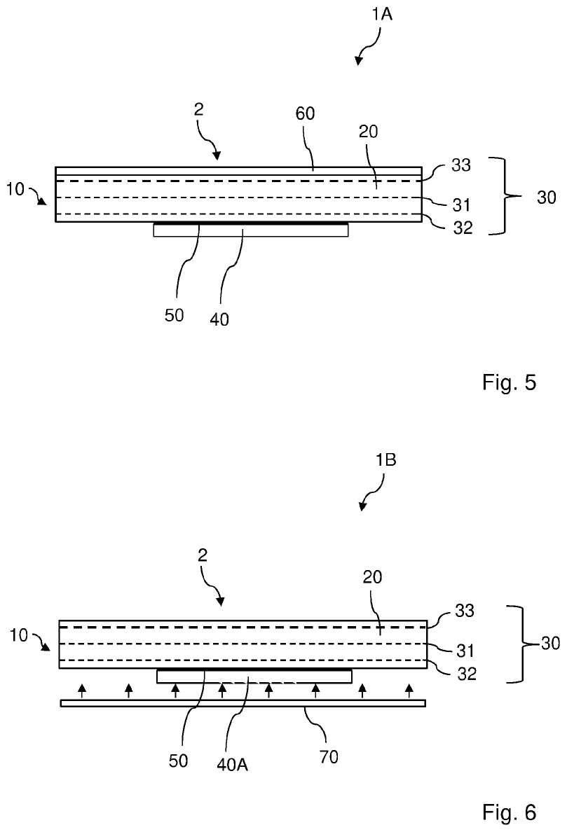

FIG. 3 and FIG. 4 show the illustrative visible component 1 with deactivated and activated touch display. If the touch display 40 is deactivated, the visible component 1 acts like a conventional component in a visible fiber look. The visible layer 33 is apparent through the polymer matrix. With activated touch display 40, the display thereof becomes visible through the fiber composite structure. By virtue of the use of a metallized glass fiber layer 33, a portion of the light from the touch display 40 also passes through the metallized glass fiber layer 33. The metallization or vapor-deposited metal is so thin that the glass fiber layer 33 is translucent with respect to light. The outward effect in the illuminated state is thus that the structure of the visible layer in the background and the touch display are readily apparent.

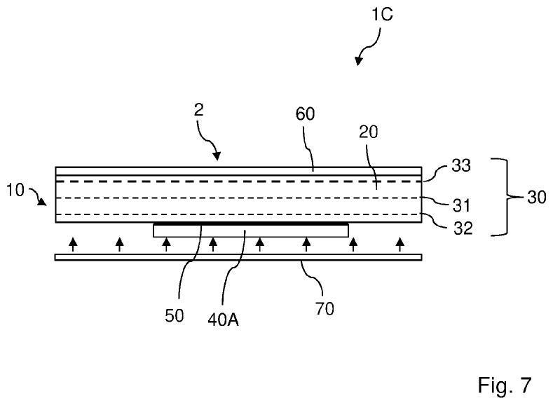

FIGS. 5, 6 and 7 show further alternative visible components 1A, 1B and 1C. Where identical reference numerals are used, these are identical features that will not be described again.

The visible component 1A, as well is the above-described structure, also has a color filter layer 60 which is on the visible side 2 and is formed, for example, by a color paint layer or color glaze. This may be disposed directly on the fiber composite body 10, or there may be one or more additional layers, for example an adhesion promoter layer, disposed between the fiber composite body 10 and the color filter layer 60. This acts like a color filter, i.e. absorb some of the light and transmits the rest of the light (e.g. a particular color of light). The color filter layer enables additional color effects.

The visible component 1B in FIG. 6 differs from the visible component 1 in that the touch display 40A used is a transparent OLED touch display and, in addition, a light source 70 is provided, disposed on a side of the touch display 40A remote from the visible layer 33. This may be secured, for example, on the touch display 40A with or without a separation or may be disposed thereon in some other locally fixed manner. Light is emitted from the light source 70 through the touch display 40A in the direction of the fiber composite body 10. The light penetrates through the fiber composite body 10 and exits therefrom on the visible side 2. Because of the use of a largely transparent polymer matrix 20 and the fiber reinforcement 30, only a small portion of the light emitted by the light source 70 is absorbed or reflected, and the intensity of the light that exits on the visible side 1 is reduced only slightly. The light source 70, together with the touch display or alternately, can generate additional light effects in the component.

The visible component 1C in FIG. 7 corresponds to the visible component 1, but additionally has, on the visible side of the fiber composite body 10, the color layer filter 60 described for FIG. 5, which makes it possible to still further enhance the optical effect achievable in the visible component 1C.

The construction of the glass fiber body 10 with one visible layer 33 and two structure layers composed of glass fibers, as shown in the figures, showed unlimited operability of the touch display in experiments. The fiber composite bodies in the experiments had wall thicknesses of 0.6 mm to 0.9 mm. The visible layer used was a layer of aluminum-metallized glass fiber roving plain weave with a basis weight of 270 g/m² and an aluminum layer thickness of 60 nm. Such a weave can be sourced, for example, under the Alutex or RV270 name from Dr. Gunther Kast GmbH & Co. KG. Although operability decreases with increasing thickness of the fiber composite body and increasing number of glass fiber layers, depending on the required sensitivity of the touch operation, the described functionality is still maintained even in the case of more than two structure layers and a greater component thickness. Therefore, the structure shown is purely by way of example and shall not be limited to the exact number of fiber layers shown.

The figures show the visible component as a flat component. The visible component may of course also have a three-dimensional surface profile; in that case, the touch display 40, 40A is preferably configured as a flexible display and matched to the profile of the component.

### LIST OF REFERENCE NUMERALS

1, 1A-1C visible component
2 visible side
10 fiber composite body
20 polymer matrix
30 fiber reinforcement
31, 32 structure layers
33 visible layer
40, 40A touch display
50 adhesive layer
60 color filter layer
70 light source

1.-14. (canceled)

15. A visible component for a motor vehicle, the visible component comprising:
a fiber-reinforced polymer component having a multilayer fiber reinforcement incorporated into an at least largely transparent polymer matrix, wherein the fiber reinforcement is formed by a visible layer in a form of a metallized glass fiber layer and at least one largely transparent structure layer; and
a touch display which is disposed on a reverse side of the fiber-reinforced polymer component which is remote from the visible layer.

16. The visible component as claimed in claim 15, wherein:
the touch display is bonded to the reverse side of the fiber-reinforced polymer component.

17. The visible component as claimed in claim 15, wherein:
the visible layer is a metallized glass fiber layer.

18. The visible component as claimed in claim 15, wherein:
the at least one largely transparent structure layer takes a form of a glass fiber layer.

19. The visible component as claimed in claim 15, wherein:
all structure layers take a form of a glass fiber layer.

20. The visible component as claimed in claim 15, wherein:
the at least one largely transparent structure layer is formed by a weave, laid scrim, knit, nonwoven or braid.

21. The visible component as claimed in claim 15, wherein:
the visible layer is formed by a weave, laid scrim, knit, nonwoven or braid.

22. The visible component as claimed in claim 15, wherein:
the polymer matrix is a thermoset polymer matrix.

23. The visible component as claimed in claim 15, further comprising at least one color filter layer disposed atop the fiber-reinforced polymer component.

24. The visible component as claimed in claim 15, wherein:
the touch display is a transparent display,
a light source is disposed on a side of the touch display remote from the visible layer, and
light emitted from the light source backlights the touch display and the fiber-reinforced polymer component in a direction of the visible layer.

25. The visible component as claimed in claim 15, wherein:
the visible component has a three-dimensional surface, and
a flexible display is installed as a touch display.

26. The visible component as claimed in claim 15, wherein the visible component is an interior component of a motor vehicle.

27. The visible component as claimed in claim 15, wherein the visible component is an exterior component of a motor vehicle.

28. A motor vehicle comprising the visible component as claimed in claim 15.

29. The motor vehicle as claimed in claim 28, wherein:
the touch display is configured to operate a vehicle component.
